(19) United States
(12) Patent Application Publication
(10) Pub. No.: US 2015/0106800 A1
(43) Pub. Date: Apr. 16, 2015

(54) INSTALLATION CONTROLLING DEVICE, AND METHOD THEREOF

(71) Applicant: POWER-ALL NETWORKS LIMITED, Shatin (HK)

(72) Inventor: STEVE LAP WAI HUI, Shatin (HK)

(21) Appl. No.: 14/511,395

(22) Filed: Oct. 10, 2014

(30) Foreign Application Priority Data
Oct. 16, 2013 (CN) 201310482095.0

(51) Int. Cl. G06F 9/445; H04L 29/06; H04L 29/08; H04L 12/24

(52) U.S. Cl. CPC G06F 8/61; H04L 41/20; H04L 63/0428; H04L 67/02
USPC 717/176

(57) ABSTRACT

An installation controlling method includes: receiving an installation request, wherein the installation request includes a network address of a gateway device to which a terminal device needs to install the operating system connects, and information of the operating system to be installed; establishing a virtual private network (VPN) channel between an installation controlling device and the gateway device according to the network address of the gateway device; determining whether one internal network port has connected to a terminal device, and determining whether the terminal device needs to install the operating system; determining a path between the installation controlling device and the gateway device and passing through the VPN channel as an installation path; and executing corresponding operating system installation software to install the corresponding operating system on the terminal device via the determined installation path.

### CROSS-REFERENCE TO RELATED APPLICATIONS

This application claims priority to Chinese Patent Application No. 201310482095.0 filed on Oct. 16, 2013, the contents of which are incorporated by reference herein.

### FIELD

The present disclosure relates to controlling devices, and particularly to a installation controlling device, and a method thereof.

### BACKGROUND

Nowadays, a usual method to install an operating system to a computer (such as a personal computer or a server) is by driving a storage unit (such as, a compact disk or a flash memory) storing an operating system installation software. However, installing the operating system to the computer via the storage unit may be complex for some peoples.

### BRIEF DESCRIPTION OF THE DRAWINGS

Implementations of the present technology will now be described, by way of example only, with reference to the attached figures.

FIG. 1 is a block diagram of an installation controlling device connected to a gateway device.

FIG. 2 is a block diagram of an installation controlling system running in the installation controlling device of FIG. 1.

FIG. 3 is a block diagram of a first embodiment of an installation object determining module of the installation controlling system of FIG. 2.

FIG. 4 is a block diagram of a management interface provided by the installation controlling device of FIG. 1.

FIG. 5 is a block diagram of a second embodiment of an installation object determining module of the installation controlling system of FIG. 2.

FIG. 6 is a flowchart diagram of an embodiment of a installation controlling method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage unit. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected.

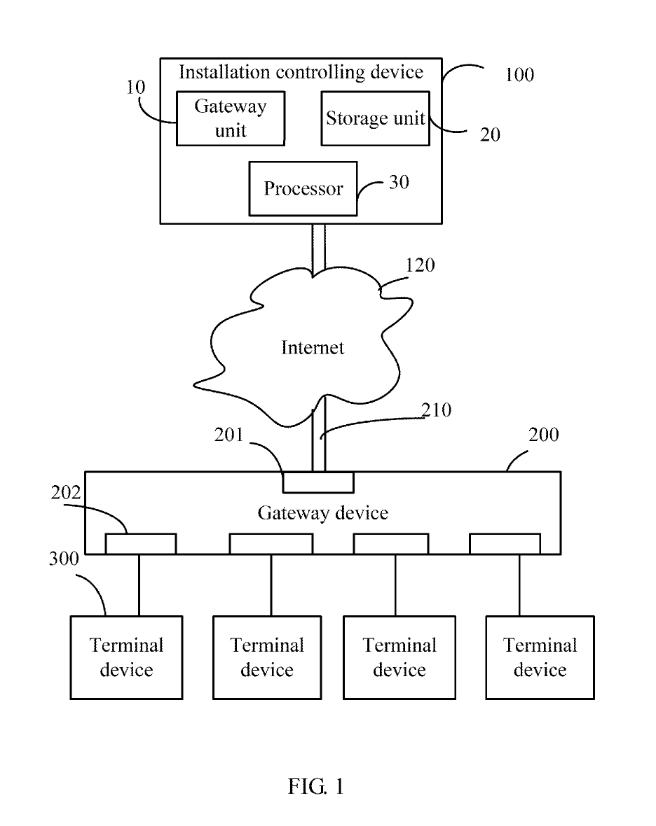

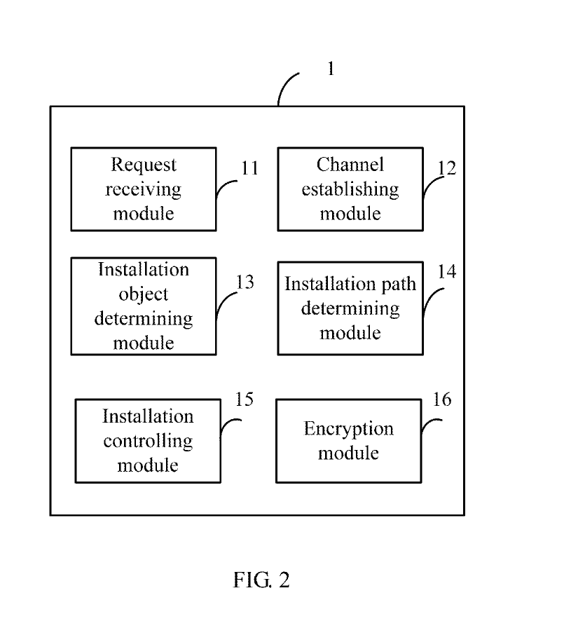

Referring to FIGS. 1 and 2, an installation controlling device 100 is connected to at least one gateway device 200 via Internet 120. The gateway device 200 is used to connect to at least one terminal device 300 which needs to install operating system. The gateway device 200 includes an external network port 201 and at least one internal network port 202. The external network port 201 is used to connect to the installation controlling device 100 via the Internet 120. Each internal network port 202 is used to connect to one terminal device 300.

The installation controlling device 100 includes a gateway unit 10, a storage unit 20, and a processor 30. The storage unit 20 stores a number of operating system installation software for installing different kinds of operating systems. In the embodiment, the installation controlling device 100 can be a server or a server group, such as a server group including Dynamic host configuration protocol (DHCP) servers and Trivial File Transfer Protocol (TFTP) servers. The gateway unit 10 can be a router or a virtual cloud gateway. In detail, when the installation controlling device 100 is a single server, the gateway unit 10 can be the router, when the installation controlling device 100 is the server group, the gateway unit 10 can be the virtual cloud gateway. The installation controlling device 100 connects to the external network port 201 of the gateway device 200 via the gateway unit 10.

In the embodiment, the gateway device 200 can be a router or a switch. The terminal device 300 can be a tablet computer, a desktop computer, a portable computer, a server, and other devices need to being installed corresponding operating systems. In the embodiment, the operating system can be a WINDOWS® operating system, a LINUX® operating, and the like. In other embodiments, the operating system or can be a virtual machine (VM) system.

An installation controlling system 1 is stored in the storage unit 20 and executed by the processor 30. The installation controlling system 1 includes a request receiving module 11, a channel establishing module 12, an installation object determining module 13, an installation path determining module 14, an installation controlling module 15, and an encryption module 16. The modules of the installation controlling system 1 can be collections of software instructions stored in the storage unit 20 and executed by the processor 30, or can include functionality represented as hardware or integrated circuits, or as software and hardware combinations, such as a special-purpose processor or a general-purpose processor with special-purpose firmware.

In one embodiment, the processor 30 can be a central processing unit, a digital signal processor, or a single chip, for example. In one embodiment, the storage unit 20 can be an internal storage system, such as a flash memory, a random access memory (RAM) for temporary storage of information, and/or a read-only memory (ROM) for permanent storage of information. The storage unit 20 can also be a storage system, such as a hard disk, a storage card, or a data storage medium. The storage unit 20 can include volatile and/or non-volatile storage units. In at least one embodiment, the storage unit 20 can include two or more storage units such that one storage unit is a memory and the other storage unit is a hard drive. Additionally, one or more of the storage units 20 can be located either entirely or partially external relative to the installation controlling device 1.

The request receiving module 11 is used to receive an installation request for installing operating system from a user, the installation request includes a network address of a gateway device 200 to which the terminal device 300 needs to install the operating system connects, and information of the operating system to be installed.

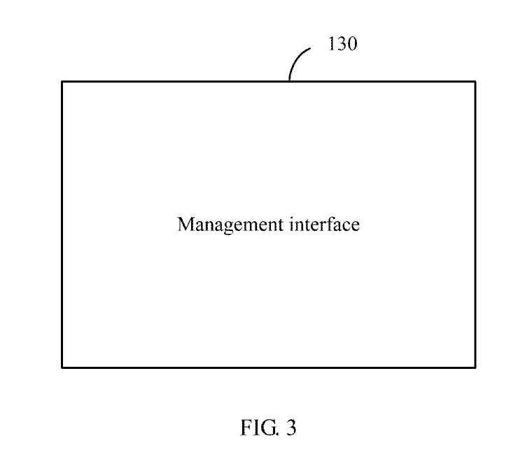

Referring to FIG. 3, in one embodiment, when a user needs to install the operating system to the terminal device 300, the user can log in a management interface 13 provided by the installation controlling device 100 to input the network address of the gateway device 200 and the information of the operating system to be installed and then submit the installation request. The network address of the gateway device 200 can be an Internet protocol (IP) address. The information of the operating system to be installed can be a name of the operating system.

The channel establishing module 12 is used to establish a virtual private network (VPN) channel 210 between the installation controlling device 100 and the gateway device 200 according to the network address of the gateway device 200. In the embodiment, the VPN channel 210 is established based on the Internet 120 and passes through the Internet 120. The VPN channel 210 can be a virtual lease line.

The installation object determining module 13 is used to determine whether one internal network port 202 of the gateway device 200 has connected to the terminal device 300, and determine whether the terminal device 300 connected to the internal network port 202 of the gateway device 200 needs to install the operating system.

The installation path determining module 14 determines a path between the installation controlling device 100 and the internal network port 202 of the gateway device 200 via the VPN channel 210 as an installation path when the installation object determining module 13 determines the terminal device 300 needs to install the operating system.

The installation controlling module 15 is used to determine corresponding operating system installation software according to the information of the operating system included in the installation request. The installation controlling module 15 further executes the corresponding operating system installation software to install the corresponding operating system on the terminal device 300 via the installation path determined by the installation path determining module 14.

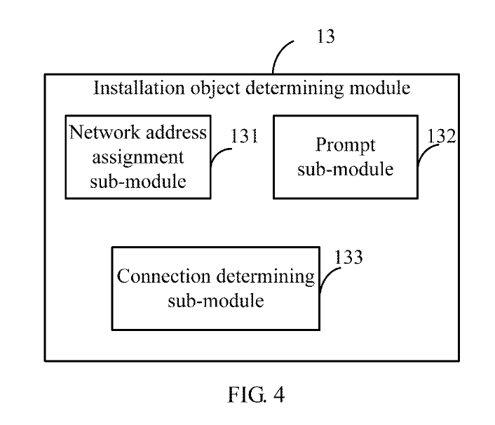

Referring to FIG. 4, a block diagram of the installation object determining module 13 of a first embodiment is illustrated. In the first embodiment, the installation object determining module 13 includes a network address assignment sub-module 131, a prompt sub-module 132, and a connection determining sub-module 133.

The network address assignment sub-module 131 is used to determine which internal network ports 202 of the gateway device 200 are preselected as installation ports each used to connect to the terminal device 300 needs to install the operating system, and assign subnet addresses to the internal network ports 202 preselected as the installation ports, and respectively associates the subnet addresses with the internal network ports 202. For example, when the network address assignment sub-module 131 determines a first internal network port 202 and a second internal network port 202 of the gateway device 200 are preselected as the installation ports, the network address assignment sub-module 131 assigns a first subnet addresses to the first internal network port 202 and associates the first subnet addresses with the first internal network port 202. The network address assignment sub-module 131 further assigns a second subnet addresses to the second internal network port 202 and associates the second subnet addresses with the second internal network port 202. In the embodiment, the internal network ports 202 preselected as the installation ports are preselected by default or preselected by the user.

The prompt sub-module 132 is used to produce a prompt signal to prompt the user to connect the terminal device 300 needs to install operating system to one of the internal network ports 202 preselected as the installation port. In one embodiment, the prompt module 132 can provide the prompt signal to the user via the management interface 103 provided by the installation controlling device 100. For example, when the user logs in the management interface 103 to submit the installation request, the channel establishing module 12 and the network address assignment sub-module 131 executes the above functions, and the prompt sub-module 132 provides the prompt signal on the management interface 103 after the network address assignment sub-module 131 assigns the subnet address to the internal network port 202. For example, the prompt signal can include: “please connect the terminal device to the first internal network port or the second internal network port”. In another embodiment, the installation request submitted by the user further includes a cell phone number, the prompt sub-module 132 provides the prompt signal in a format of short message to the user via the cell phone number.

The connection determining sub-module 133 determines the terminal device 300 connected to the internal network port 202 preselected as the installation port as the terminal device 300 needs to install the operating system.

Therefore, as described above, the installation path determining module 14 determines the installation path and the installation controlling module 15 installs the corresponding operating system on the terminal device 300 via the installation path.

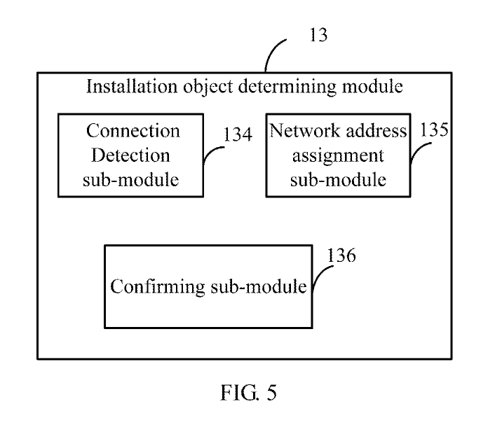

Referring to FIG. 5, a block diagram of the installation object determining module 13 of a second embodiment is illustrated. In the second embodiment, the installation object determining module 13 includes a connection detection sub-module 134, a network address assignment sub-module 135, and a confirming sub-module 136.

The connection detection sub-module 134 is used to detect whether one or more internal network port 202 of the gateway device 200 are connected to a corresponding terminal devices 300. In one embodiment, when the user connects the terminal device 300 to one internal network port 202 of the gateway device 200, the connection detection sub-module 134 determines the terminal device 300 is connected to the internal network port 202 of the gateway device 200 via a handshake protocol, and determines the internal network port 202 connected to the terminal device 300.

The network address assignment sub-module 135 is used to assign a corresponding subnet address to the internal network port 202 connected to the terminal device 300. The subnet address can be a subnet IP address.

The confirming sub-module 136 is used to provide a confirm information to the user to confirm whether the terminal device 300 connected to the internal network address is the terminal device 300 needs to install the operating system. The confirming sub-module 136 determines the terminal device 300 connected to the internal network address is the terminal device 300 needs to install the operating system if the user selects “Yes”. For example, the confirm information can include: “please confirm whether the terminal device now connected to the internal network address is needed to install the operating system”.

Similarly, the confirming sub-module 136 can provide the confirm information to the user via the management interface 103 of the installation controlling device 200. When the user logs in the management interface 103 to submit the installation request via another terminal device 300 already has installed the operating system, the channel establishing module 12 and the network address assignment sub-module 135 executes the above functions, and the confirming sub-module 136 provides the confirm information on the management interface 103 after the network address assignment sub-module 135 assigns the subnet address to the internal network port 202. In another embodiment, the installation request submitted by the user further includes a cell phone number, the confirming sub-module 136 provides the confirm information in a format of short message to the user via the cell phone number.

Therefore, as described above, the installation path determining module 14 determines the installation path and the installation controlling module 15 installs the corresponding operating system on the terminal device 300 via the installation path.

In the second embodiment, the user can connect the terminal device 300 to any one of the internal network port 202 of the gateway device 200 to install the operating system on the terminal device 300.

In the present disclosure, when the user needs to install the operating system via cloud, the user can set the terminal device 300 to first started up from network via a BOOT system of the terminal device 300.

In the embodiment, the encryption module 16 is used to encrypt data transmitted between the installation controlling device 100 and the gateway device 200 via the VPN channel 210. For example, before the installation controlling module 15 installs the operating system on the terminal device 300 connected to the gateway device 200, the encryption module 16 encrypts data of the operating system installation software used to install the operating system.

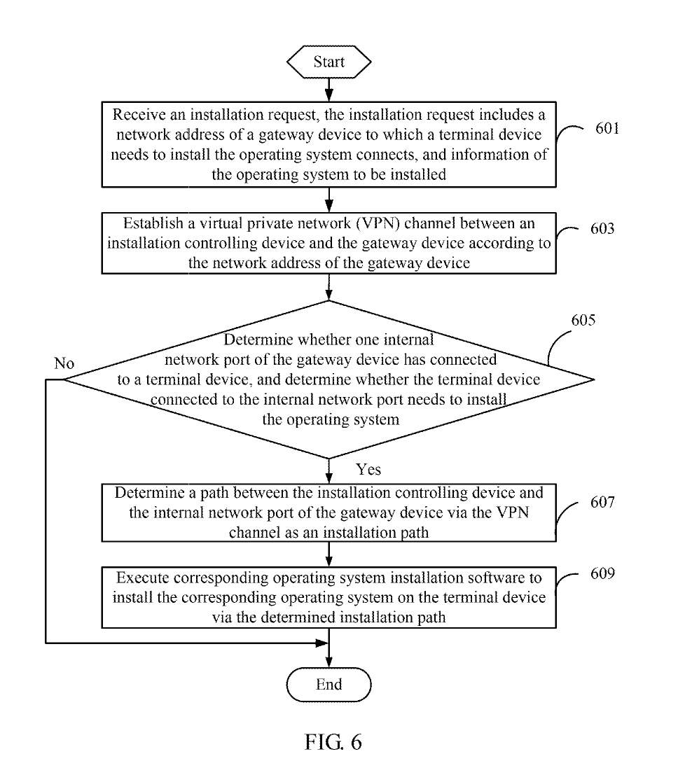

FIG. 6 illustrates a flowchart of the installation controlling method. The method is provided by way of example, as there are a variety of ways to carry out the method. The method described below can be carried out using the configurations illustrated in FIG. 1, for example, and various elements of these figures are referenced in explaining the example method. Each block shown in FIG. 6 represents one or more processes, methods, or subroutines carried out in the example method. Additionally, the illustrated order of blocks is by example only and the order of the blocks can be changed. The example method can begin at block 601.

In block 601, a request receiving module receives an installation request for installing operating system, the installation request includes a network address of a gateway device to which a terminal device needs to be installed the operating system connects, and information of the operating system to be installed.

In block 603, a channel establishing module establishes a virtual private network (VPN) channel between a installation controlling device and the gateway device according to the network address of the gateway device.

In block 605, an installation object determining module determines whether one internal network port of the gateway device has connected to the terminal device, and determines whether the terminal device connected to the internal network port of the gateway device needs to install the operating system. If the terminal device connected to the internal network port of the gateway device needs to install the operating system, the process jumps to block 607, else, the process is ended.

In block 607, a installation path determining module determines a path started at the installation controlling device and ended at the internal network port of the gateway device via the VPN channel as an installation path.

In block 609, an installation controlling module determines corresponding operating system installation software according to the information of the operating system included in the installation request, and executes the corresponding operating system installation software to install the corresponding operating system on the terminal device via the determined installation path.

In the embodiment, the installation controlling method can further include: an encryption module encrypts data of the operating system installation software used to install the operating system data before the installation controlling module installs the operating system on the terminal device via the installation path.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An installation controlling device comprising:
a storage device configured to store a plurality of modules which are collections of instructions and a plurality of operating system installation software for installing different kinds of operating systems; and
at least one processor configured to execute the plurality of modules which are collections of instructions, the modules comprising:
a request receiving module configured to receive an installation request for installing operating system from a user, wherein the installation request comprises a network address of a gateway device to which a terminal device needs to install the operating system connects, and information of the operating system to be installed;
a channel establishing module configured to establish a virtual private network (VPN) channel between the installation controlling device and the gateway device according to the network address of the gateway device;
an installation object determining module configured to determine whether one internal network port of the gateway device has connected to the terminal device, and determine whether the terminal device connected to the internal network port of the gateway device needs to install the operating system;
an installation path determining module configured to determine a path between the installation controlling device and the internal network port of the gateway device via the VPN channel as an installation path when the installation object determining module determines the terminal device connected to the internal network port of the gateway device needs to install the operating system; and
an installation controlling module configured to determine corresponding operating system installation software according to the information of the operating system comprised in the installation request, and to execute the corresponding operating system installation software to install the corresponding operating system on the terminal device via the determined installation path.

2. The device according to claim 1, wherein the modules further comprise an encryption module configured to encrypt data transmitted between the installation controlling device and the gateway device via the VPN channel, and further configured to encrypt data of the operating system installation software used to install the operating system.

3. The device according to claim 1, wherein the installation object determining module comprises a network address assignment sub-module, a prompt sub-module, and a connection determining sub-module, the network address assignment sub-module is configured to determine which internal network ports of the gateway device are preselected as installation ports each used to connect to one terminal device needs to install the operating system, and assign subnet addresses to the internal network ports preselected as the installation ports, and respectively associate the subnet addresses with the internal network ports; the prompt sub-module is configured to produce a prompt signal to prompt the user to connect the terminal device needs to install operating system to one of the internal network ports preselected as the installation port; and the connection determining sub-module is configured to determine the terminal device connected to the internal network port preselected as the installation port as the terminal device needs to install the operating system.

4. The device according to claim 3, wherein the prompt module provides the prompt signal to the user via a management interface provided by the installation controlling device.

5. The device according to claim 1, wherein the installation object determining module comprises a connection detection sub-module, a network address assignment sub-module, and a confirming sub-module; the connection detection sub-module is configured to detect whether one or more internal network port of the gateway device are connected to a corresponding terminal device; the network address assignment sub-module is configured to assign a corresponding subnet address to the internal network port connected to the terminal device; and the confirming sub-module is configured to provide a confirm information to the user to confirm whether the terminal device connected to the internal network address is the terminal device needs to install the operating system, and determine the terminal device connected to the internal network address is the terminal device needs to install the operating system if the user selects “Yes”.

6. The device according to claim 5, wherein the confirming sub-module provides the confirm information to the user via a management interface provided by the installation controlling device.

7. The device according to claim 1, wherein the installation controlling device is a server or a server group.

8. The device according to claim 1, wherein the different kinds of operating systems comprises a WINDOWS® operating system, a LINUX® operating system, a virtual machine system.

9. A computer operating system installation controlling method comprising:
receiving from a user a request to install a computer operating system on a terminal device, the requesting including a network address of a gateway device for the terminal device and identification of the requested operating system;
using the network address of the gateway device to establish a virtual private network channel between an installation controlling device and the gateway device;
confirming connection between the gateway device and the terminal device;
determining an installation path from the installation controlling device to the gateway device over the virtual private network channel;
selecting necessary operating system installation software based on requested operating system; and
executing the operating installation software to install the requested operating system on the terminal device using the determined installation path.

10. The method according to claim 9, further comprising:
encrypting data of the operating system installation software used to install the operating system when installing the operating system on the terminal device connected to the gateway device.

11. The method according to claim 9, wherein the step of confirming connection between the gateway device and the terminal device comprising:
determining whether one internal network port of the gateway device has connected to a terminal device, and determining whether the terminal device connected to the internal network port of the gateway device needs to install the operating system.

12. The method according to claim 11, wherein the step of determining whether one internal network port of the gateway device has connected to a terminal device, and determining whether the terminal device connected to the internal network port of the gateway device needs to install the operating system comprising:
determining which internal network ports of the gateway device are preselected as installation ports each used to connect to one terminal device need to install the operating system;
assigning subnet addresses to the internal network ports preselected as the installation ports and respectively associating the subnet addresses with the internal network ports;
producing a prompt signal to prompt the user to connect the terminal device needs to install operating system to one of the internal network ports preselected as the installation ports; and
determining the terminal device connected to the internal network port preselected as the installation ports as the terminal device needs to install the operating system.

13. The method according to claim 11, wherein the step of determining whether one internal network port of the gateway device has connected to a terminal device, and determining whether the terminal device connected to the internal network port of the gateway device needs to install the operating system comprising:
detecting whether one or more internal network port of the gateway device are connected to a corresponding terminal device;
assigning a corresponding subnet address to the internal network port connected to the terminal device;
providing a confirm information to the user to confirm whether the terminal device connected to the internal network address is the terminal device needs to install the operating system; and
determining the terminal device connected to the internal network address is the terminal device needs to install the operating system if the user selects “Yes”.

14. The method according to claim 11, wherein the step of determining an installation path from the installation controlling device to the gateway device over the virtual private network channel comprising:
determining a path started at the installation controlling device and ended at the internal network port of the gateway device via the VPN channel as an installation path if the terminal device connected to the internal network port of the gateway device needs to install the operating system.

15. A non-transitory storage medium having stored thereon instructions that, when executed by at least one processor, causes the least one processor to execute instructions of a method for automatically installing operating system, the method comprising:
receiving an installation request for installing operating system from a user, wherein the installation request comprises a network address of a gateway device to which a terminal device needs to install the operating system connects, and information of the operating system to be installed;
establishing a virtual private network (VPN) channel between an installation controlling device and the gateway device according to the network address of the gateway device;
determining whether one internal network port of the gateway device has connected to a terminal device, and determining whether the terminal device connected to the internal network port of the gateway device needs to install the operating system;
determining a path started at the installation controlling device and ended at the internal network port of the gateway device via the VPN channel as an installation path; and
determining corresponding operating system installation software according to the information of the operating system comprised in the installation request, and executing the corresponding operating system installation software to install the corresponding operating system on the terminal device via the determined installation path.

16. The non-transitory storage medium according to claim 15, wherein the method further comprising:
encrypting data of the operating system installation software used to install the operating system when installing the operating system on the terminal device connected to the gateway device.

17. The non-transitory storage medium according to claim 15, wherein the step of determining whether one internal network port of the gateway device has connected to a terminal device, and determining whether the terminal device connected to the internal network port of the gateway device needs to install the operating system comprising:
determining which internal network ports of the gateway device are preselected as installation ports each used to connect to one terminal device needs to install operating system;
assigning subnet addresses to the internal network ports preselected as the installation ports and respectively associating the subnet addresses with the internal network ports;
producing a prompt signal to prompt the user to connect the terminal device needs to install operating system to one of the internal network ports preselected as the installation port; and
determining the terminal device connected to the internal network port preselected as the installation port as the terminal device needs to install the operating system.

18. The non-transitory storage medium according to claim 15, wherein the step of determining whether one internal network port of the gateway device has connected to a terminal device, and determining whether the terminal device connected to the internal network port of the gateway device needs to install the operating system comprising:
detecting whether one or more internal network port of the gateway device are connected to a corresponding terminal device;
assigning a corresponding subnet address to the internal network port connected to the terminal device;
providing a confirm information to the user to confirm whether the terminal device connected to the internal network address is the terminal device needs to install the operating system; and
determining the terminal device connected to the internal network address is the terminal device needs to install the operating system if the user selects “Yes”.
